(19) United States
(12) Patent Application Publication
(10) Pub. No.: US 2002/0191685 A1
(43) Pub. Date: Dec. 19, 2002

(54) System and method for self-testing a QAM transceiver within a CATV system

(76) Inventor: Eric M. Sadowski, Indianapolis, IN (US)

Correspondence Address: Harold C. Moore, Maginot, Addison & Moore, Bank One Center/Tower, 111 Monument Circle, Suite 3000, Indianapolis, IN, 46204-5115, US

(21) Appl. No.: 09/881,506

(22) Filed: Jun. 14, 2001

(51) Int. Cl. H04B 3/46

(52) U.S. Cl. 375/224; 375/298; 455/226.1

(57) ABSTRACT

A test system determines the response of a QAM receiver in relative isolation from a communication channel of a CATV network. The system includes a test coupler to couple the output of a QAM transmitter to a QAM receiver and a controller for configuring the QAM transmitter and QAM receiver within a component to communicate with one another. The system of the present invention makes use of the QAM transmitter provided, for other purposes, in an ASIC implementing the QAM receiver. The operation of the test controller of the test system permits the QAM receiver to be tested without the need for external test equipment. The test controller provides the QAM transmitter with a data signal for modulating an identified carrier frequency for purposes of the internal test. The response of the receiver to the test signal generated by the transmitter is captured and evaluated to determine the characteristics of the receiver. If the unit under test requires service, a service message may be generated and sent by the transmitter to the head end. Thus, information about the receiver response may be gathered without using sweep tests that involve components located at other sites in the network and the receiver may be evaluated without requiring expensive test equipment.

### FIELD OF THE INVENTION

The present invention relates generally to analyzing transmission characteristics of a component in a RF communication network, and more particularly, to analyzing the response of a receiver located at a distribution site or subscriber site in a CATV communication network.

### BACKGROUND OF THE INVENTION

In broad terms, a radio frequency (“RF”) communication network supports transmission of information signals from a source location to a destination location through (or “over” or “on”) an RF communication channel. Depending on the application, the information signals may be analog or digital in nature. Digital signals tend to afford significant advantages relative to analog techniques, such as, for example, improved noise immunity and facilities for encryption, which can provide enhanced communication reliability and security, respectively.

Analog and digital transmissions propagate an information signal through a communication medium by converting the information signal into a form suitable for effective transmission over the medium. The propagation medium of an RF communication network may support the simultaneous transmission of more than one information signal by dividing the frequency spectrum of the propagation medium into discrete bandwidth groupings called channels and providing a carrier wave for each channel. The information signal is usually used to vary a parameter of the carrier wave for a channel so the frequency spectrum of the modulated carrier is confined within the bandwidth of one of the channels defined for a propagation medium.

A receiver at a destination location receives the modulated carrier waves for the channels to which the receiver is tuned. The received may then recover a version of the original information signal from the modulated carrier received from the corresponding channel of the propagation medium. The recovery process includes demodulation of the received signal in a manner that is generally the inverse of the modulation performed by the source transmitter.

A cable television (“CATV”) network is one type of RF communication network. CATV networks have grown in importance and use for transmitting television and other information signals to various analog and/or digital devices such as analog television sets and/or personal computers, respectively, and, lately, for a growing number of digital television sets. Originally, CATV networks were used in locations that could not directly receive over-the-air television transmissions because of large distances between transmitters and receivers or because of interfering buildings or terrain. The propagation medium for such systems is coaxial cable because it shields signals carried by the cable from electromagnetic and radio frequency interference better than air. RF communication networks that transmit signals principally through the earth's atmosphere (such as traditional radio and television networks) are prone to noise interference and they require a “line of sight” communication path. In recent years, cable transmissions have become popular even in areas where receptions of over-the-air television broadcasts are satisfactory.

In these areas, the wide bandwidth of CATV networks has been increasingly exploited to provide additional channels and new services that have not been available from traditional television networks, such as bi-directional communications and videotext. Bi-directional communication may be implemented on a single coaxial cable by dividing the available frequency spectrum of a channel on the cable into two sub-channels. The forward sub-channel carries signals in the forward or downstream (away from the head end) direction and the return sub-channel carries signals in the reverse or upstream (toward the head end) direction.

A typical CATV system includes a head end where information signals are originated for distribution to subscribers over a network of coaxial cable. Cable modems or the like located at individual subscriber sites are coupled to the network through taps. Also, disbursed throughout the network are distribution sites where amplifiers are located. These amplifiers may include filters that are used to remove distortions in the signals and then the filtered signal is amplified to ensure an adequate signal-to-noise ratio (SNR) of the signal is maintained during its propagation through the system to the next distribution site or tap.

A cable modem or the like at the customer site receives signals from the head end on a forward sub-channel and transmits signals to the head end on a return sub-channel. The receiver in the cable modem typically is configured to receive at least a 64 quadrature amplitude modulated (QAM) signal while the transmitter of the modem provides a PCSK or QAM 16 signal. The bandwidth of the transmitter is smaller than the bandwidth of the receiver because the video content of the information signal from the head end is greater than the information content of the customer's responses.

As the number of customers and the development of new services grow, the electrical loads on the network increase and the communication operations of a CATV network becomes increasingly complex. CATV networks not only require verification testing during construction and/or expansion to confirm that the network can reliably carry signals but further periodic testing is required to ensure the transmission design characteristics of the network remain stable. Additionally, complex RF communication networks, such as CATV networks, suffer occasional problems and failures from component failure or fatigue. One component that frequently causes service disruption is the cable modem that couples the customer site to the network. When such problems arise, the component causing the problem must be located so that it may be repaired or replaced.

One method used for verifying reliable operation of a CATV and other RF communication networks is known as sweep testing. Sweep testing requires a transmitter at a first location in the network for the injection of a test signal into the network and the coupling of an analyzer at the unit under test. Sweep testing is resource intensive because it requires the coupling of external equipment and components to the network and negatively impacts network throughput because the test signal occupies a portion of the network bandwidth.

Although sweep testing is often necessary to maintain and optimize a network, a significant number of sweep testing operations arise from events triggered by subscriber or end-user equipment failures. In particular, if a CATV subscriber has complaints about reception quality, a technician may be dispatched to diagnose the problem. To this end, the technician may employ a sweep test device or other test device. Such diagnosis and testing may be inefficient if the problem is in the CATV subscriber's receiver.

What is needed is a method of CATV network component testing that facilitates detection of a source of a problem in a network while reducing the need for the coupling of external equipment and components to the network.

What is also needed is a method of CATV network component testing that does not negatively impact the bandwidth of a channel or sub-channel in the network.

### SUMMARY OF THE INVENTION

The limitations of the previously known CATV network testing devices are overcome by a system implementing the method of the present invention. The system includes a test controller for configuring a quadrature amplitude modulated (QAM) receiver and a QAM transmitter located in a single component of a CATV network for an internal test and a test coupler for coupling an output of the QAM transmitter to an input of the QAM receiver. The controller captures the response of the receiver to determine the characteristics of the receiver for evaluation of the receiver. The system of the present invention makes use of the QAM transmitter located in the component having the QAM receiver to test the QAM receiver even though the bandwidth of the two components may be different during network operation. After being configured for a receiver test, the transmitter modulates a carrier frequency with a test signal that is provided through the test coupler to one of the down-conversion and demodulating components in the input path of the receiver. The test signal may be generated by a test controller that is external to the component being tested. The response of the receiver may then be captured by the test controller and evaluated to determine the operational characteristics of the receiver. Because information about the receiver response may be gathered without including the response of the channel that precedes the input of the receiver, the receiver may be evaluated in relative isolation from the channel and the evaluation does not require expensive test equipment.

Accordingly, the present invention may be implemented in a CATV network in which the failure of a receiver may be detected prior to the connection of any test equipment. While the use of test equipment may be needed in some cases, the present invention nevertheless allows for speedy detection of a faulty receiver.

The system incorporating the method of the present invention is preferably implemented using a transmitter and receiver that populate the same integrated circuit. The transmitter is configured for communication with the receiver of the integrated circuit. The output of the transmitter is coupled to the test coupler that may be controlled by the test controller to selectively couple the output of the transmitter through the test coupler to one of the components in the input path of the receiver. Otherwise the output of the transmitter is coupled to a return channel in the CATV system. A memory coupled to the controller may be used to store the receiver response and the controller may execute software to compare the stored signals for evaluation of the receiver.

The method of the present invention includes coupling the output of a QAM transmitter to a QAM receiver, both being located in a single component of a CATV network, so a test signal generated by the QAM transmitter is received by the QAM receiver, and comparing the response of the QAM receiver to the test signal to determine the receiver characteristics without channel response characteristics. The method may be supplemented by selectively controlling the coupling of the output of the transmitter to different input components of the receiver or a return channel of the CATV system.

The system and method of the present invention may be used to determine the response of a receiver of a subscriber site or distribution site in relative isolation from the communication channel of a CATV communication network. The receiver response may be determined without requiring the transportation of expensive test equipment to the subscriber site or distribution site. Accordingly, at least some CATV communication network problems can be diagnosed with reduced involvement of technician testing and reduced use of testing devices. Because a signal is not injected into the network for distribution to a plurality of subscriber or distribution sites, the bandwidth of the network is not negatively impacted.

These and other advantages and features of the present invention may be discerned from reviewing the accompanying drawings and the detailed description of the invention.

### BRIEF DESCRIPTION OF THE DRAWINGS

The present invention may take form in various components and arrangement of components and in various steps and arrangement of steps. The drawings are only for purposes of illustrating an exemplary embodiment and are not to be construed as limiting the invention.

FIG. 1 is a schematic of an exemplary CATV communication network in which the present invention may be used;

FIG. 2 is a graphical depiction of a digital modulation scheme that may be used in the network of FIG. 1;

FIG. 3 is a block diagram of a system that may be implemented at a subscriber or distribution site of the network shown in FIG. 1 to evaluate the receiver or transmitter at the site; and

FIG. 4 is a flowchart of an exemplary method that may be used in the system of FIG. 3 to evaluate the response of a channel used in the network of FIG. 1 or the receiver and transmitter of a subscriber or distribution site.

### DETAILED DESCRIPTION OF THE INVENTION

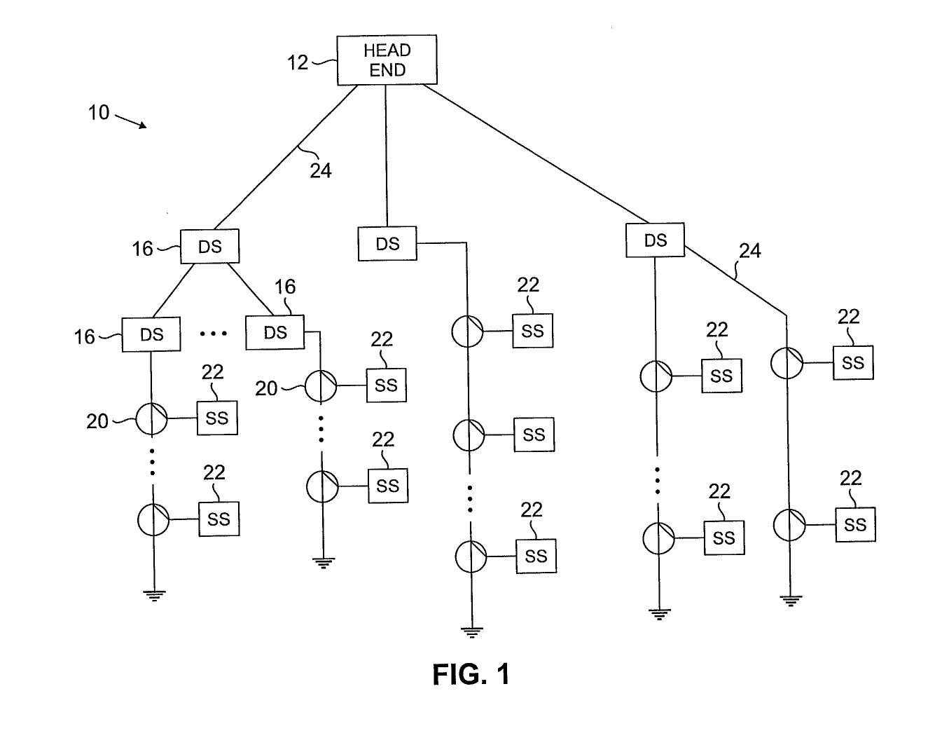

FIG. 1 depicts a schematic of a CATV communication network in which the present invention may be used. Content signals are generated via playback machines or received via satellite and the like at head end 12 of network 10 and these information signals are used to modulate carrier frequencies on various channel frequencies of network 10. Network 10 is further comprised of distribution sites 16, subscriber taps 20, and subscriber sites 22. These sites are coupled together by a propagation medium 24 that is typically coaxial cable or fiber optic cable. The frequency spectrum of the propagation medium is divided into channels that are typically 6 MHz wide and that are centered about the frequency used to define the channel. That is, some frequency ω_{ch} is the center frequency of the channel and frequencies approximately 3 MHz above and below the center frequency are deemed to be within the channel. A carrier wave at the channel frequency is modulated with an information signal to provide content for the channel. The modulated carrier frequencies for all of the channels on which network 10 provides content are transmitted via a transmitter at head end 12 to a plurality of distribution sites 16. The signals are filtered for noise and amplified for further transmission at distribution sites 16. From a distribution site 16, the signals may be delivered over propagation medium 24 to other distribution sites 16 or to a plurality of subscriber sites 22 via subscriber taps 20. Taps 20 provide the frequency spectrum of propagation medium 24 to a subscriber site 22 with little attenuation of the signals being transmitted in the bandwidth of medium 24. That is, taps 20 are designed to provided the signals on medium 24 to a subscriber site 22 without causing parasitic loss of signals on medium 24. The signals are decoded at the subscriber site by a cable modem or the like and are used to communicate with televisions, computers, or the like.

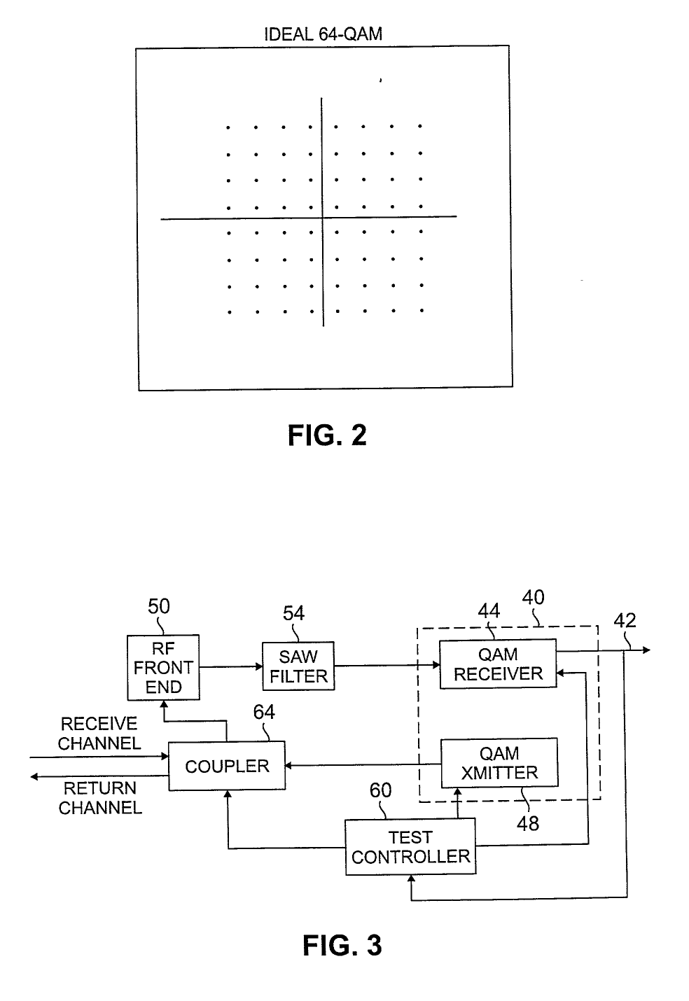

A common modulation scheme used in known CATV systems is the QAM modulation scheme. Pixel data of images, such as the pixels of a frame of moving picture data, to be transmitted over a CATV system are encoded by a known method, such as one of the Moving Picture Expert Group (MPEG) methods. Once the image data is encoded using an MPEG scheme or the like, this encoded data stream is used to modulate a carrier frequency for a channel in accordance with a known digital modulation scheme, such as QAM. The encoded data stream is used to modulate the amplitude and phase of the carrier frequency to incorporate one of a predetermined number of amplitude/phase combinations on the carrier wave. In one commonly used digital modulation scheme, there are 64/256 possible amplitude/phase combinations that may be imposed onto the carrier wave. Each of these combinations may be perceived as corresponding to a point on a graphical representation. In a QAM-64 scheme, the graphical representation is depicted in FIG. 2. As shown in FIG. 2, the 64 points of the representation are centered about zero. The horizontal and vertical axes of the graph represent the orthogonal components of a modulation signal represented by a point. Thus, each signal may be described as a (x,y) point or as a phasor having a magnitude and angle. The graphical representation shown in FIG. 2 is known as a signal constellation for a QAM signal, which in FIG. 2 is a QAM-64 signal. Signal distortions caused by a transmitter, propagation medium, or the demodulation components of a receiver may shift, attenuate, or amplify a modulation signal so it does not exactly correspond to one of the discrete points on a signal constellation for a modulation scheme. Maintenance or repair of a network 10 is an effort to locate the source of deteriorating performance within network 10 before it disrupts service in the network.

A system that includes a transceiver 40 for receiving content from the channels of system 10 and for sending information on return channels of the same system is shown in FIG. 3. Transceiver 40 includes a QAM receiver 44 and a QAM transmitter 48 for the receipt and transmission of signals over system 10, respectively. RF front end 50 and SAW filter 54 may be tuned to receive a carrier frequency for a particular channel of system 10 and demodulate the carrier frequency to provide a signal to receiver 44.

Receiver 44 applies a transfer function to compensate for distortion of the information signal during transmission over the channel. The resulting signal may then be processed to produce an MPEG signal or the like. To this end, the receiver may suitably be any well-known circuit that is operable to receive QAM or QAM-like signals. For example, the receiver 44 may suitably be the receiver portion of a cable modem, or a receiver of a digital test device, such as that described in U.S. Pat. No. 6,061,393 to Tsui et al. Likewise, the QAM transmitter 48 may be any known digital transmission device that is operable to transmit QAM or QAM-like signals.

To test the receiver 44 without requiring the coupling of external test equipment, a test controller 60 and coupler 64 are provided. Test controller 60 is coupled to QAM receiver 44 and QAM transmitter 48 for configuring those components for internal testing. Also, controller 60 provides a data signal to transmitter 48 for modulating a carrier frequency for an internal test of receiver 44 and controller 60 receives the response of receiver 44 so the response may be compared to the data signal. In this manner, test controller 60 may be used to evaluate the characteristics of receiver 44. Controller 60 also determines whether coupler 64 provides the output of transmitter 48 to RF front end 50, SAW filter 54, or to the return channel of system 10.

Test controller 60 may be a microprocessor, controller or other type of processing circuit having memory and components for display output so a user may view the results of internal testing. For example, controller 60 may be a Motorola 68331 with 2MB of RAM. The processor is preferably coupled to a display controller so it may drive an LCD or other display associated with transceiver 40 for purposes of displaying the data generated by controller 60. The microprocessor or controller is preferably coupled to the ASIC that implements transceiver 40, such as a BCM3125 manufactured by Broadcom of Irvine, Calif., by a serial/peripheral interface (SPI). The interface permits controller 60 to configure receiver 44 and transmitter 48 for internal testing.

Controller 60 may include memory for storage of data signal patterns for the internal testing of receiver 44 and to store the signal generated by receiver 44 in response to a test signal received from transmitter 48. The output of transmitter 48 is coupled to test coupler 64 which is controlled by controller 60 to couple the output of transmitter 48 to one of the components in the input path of receiver 44 or to a return channel. Controller 60 controls transmitter 48 to either generate a test signal that requires filtering by surface acoustic wave (SAW) filter 54 or an intermediate frequency (IF) down-converter in front end 50. Controller 60 may configure transmitter 48 to generate a single or multi-channel, if the transmitter is capable of multi-channel signal generation, signal for front end 50 so the operation of the front end may be verified. Controller 60 may also configure transmitter 48 so it generates a signal typically provided by a front end component 50 so the operation of SAW filter 54 may be verified. Controller 60 selectively configures coupler 64 to couple the output of transmitter 48 to the appropriate coupling point in the input path of receiver 44 that corresponds to the configuration of transmitter 48 as described previously. Although controller 60 preferably controls coupler 64 so it selectively couples the input of different components in the input path of receiver 40 to transmitter 66, coupler 64 may be a simple signal coupler, such as a section of coaxial cable terminated at each end with BNC connectors. Such a test coupler requires manual manipulation to change the location of the coupling between receiver 44 and transmitter 48 but may be used to enhance cost effectiveness.

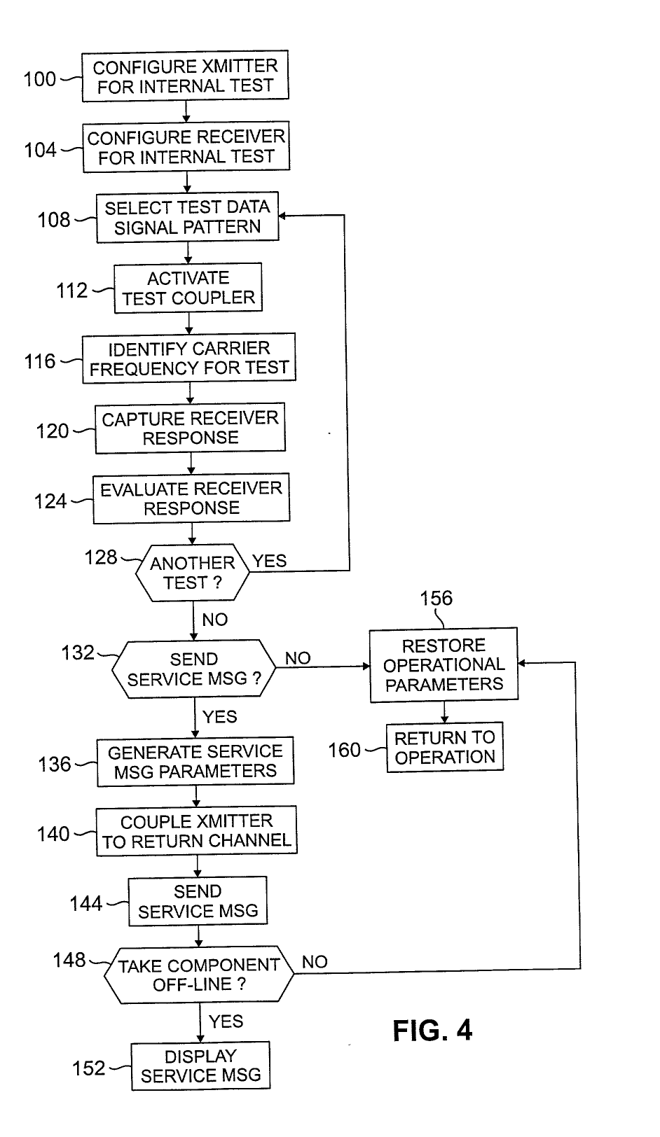

A flowchart of an exemplary process for determining the response of the components in the input path of receiver 44 is shown in FIG. 4. The process, which may be implemented in software executed by controller 60, begins by configuring transmitter 48 for internal testing (block 100). For testing a QAM 64 receiver having a SAW filter bandwidth of 6 MHz with a QAM 16 transmitter, transmitter 48 is preferably configured to have a symbol rate that is equal to or greater than 5 symbols per second up to 5.5M symbols per second. Preferably, the symbol rate for such an internal test is greater than 3M symbols per second. Transmitter 48 configuration may also include identifying a carrier frequency for modulation with a data signal, specifying whether the generated signal is single or multi-channel as well as the type of signal to be generated, i.e., one for front end 50 or SAW filter 54. Receiver 44 is then configured for an internal test by setting its QAM symbol rate to that of transmitter 48 (block 104). The process continues with the selection of a test data signal that is used by transmitter 48 to modulate a carrier frequency (block 108). The test signal preferably has a significantly long random pattern so receiver 44 may acquire the signal. For example, a well-known test signal that meets this requirement is designated within the art as PN 23. Controller 60 activates coupler 64 to provide the output of transmitter 48 to front end 50 or SAW filter 54 of receiver 44 for the internal test (block 112) and also identifies the carrier frequency and test mode for transmitter 48 (block 116). The test mode indicates whether or not transmitter 48 performs up-conversion of the generated test signal and if the signal is up-converted, the level of up-conversion. It may also specify whether the signal is multi-channel or not, depending upon the capabilities of transmitter 48. Controller 60 uses the test mode to determine whether the output of test coupler 64 couples the test signal generated by transmitter 48 to the input of SAW filter 54 or the IF down-converter in front end 50. Once the test signal is coupled to the appropriate input, the response of receiver 44 is captured and stored in memory by controller 60 (block 120). Controller 60 compares the captured signal to the test signal to evaluate the characteristics of receiver 44 (block 124). Controller 60 may then determine to execute another test with a different pattern, symbol rate, carrier frequency, or combination thereof to evaluate different characteristics or components of receiver 44 (block 128). For example, distortion detected in the receiver response to a test signal provided to front end 50 may result in the test pattern being used to provide a test signal to SAW filter 54. If the distortion of receiver 44 to that test signal is significantly reduced, then front end 50 probably requires servicing. Thus, controller 60 may determine from evaluation of the receiver responses to various test signals that transceiver 40 requires servicing (block 132). If it does, controller 60 provides a service message signal to transmitter 48 for modulation of a carrier frequency along with identification of the correct carrier frequency for service messages (block 136). Coupler 64 is activated to provide the output of transmitter 48 to the return channel (block 140) and the service message is sent (block 144). Controller 60 may be provided with pass/fail parameters that may be used to determine whether the unit under test should be taken off-line (block 148). If it should be taken off-line, a service message is displayed so the user may know that a service call has been requested (block 152). Otherwise, the operational parameters for the unit are restored (block 156) and the unit returned to operation (block 160). This action also occurs, if there is no need to send a service message (block 132).

Prior to operation, the program memory of controller 60 is programmed to include software for implementing the method described above including the various tests and combinations for detecting component failures. Once the unit containing controller 60, coupler 64, and transceiver 40 with its input components is put into operation, controller 60 may be selectively activated at the unit or by a signal received from head end 12 or the like to commence testing of receiver 44 using transmitter 48. Once the testing is terminated, the unit is either returned to operation or the unit is removed from service and the service message displayed on the display. In this manner, the receiver of a unit at a particular site may be tested using the transmitter of the transceiver without negatively impacting the bandwidth of the network or requiring external test equipment.

While the present invention has been illustrated by the description of exemplary processes, and while the various processes have been described in considerable detail, it is not the intention of the applicant to restrict or in any limit the scope of the appended claims to such detail. Additional advantages and modifications will also readily appear to those skilled in the art. The invention in its broadest aspects is therefore not limited to the specific details, implementations, or illustrative examples shown and described. Accordingly, departures may be made from such details without departing from the spirit or scope of applicant's general inventive concept.

What is claimed is:

1. An apparatus comprising:
a quadrature amplitude modulation (QAM) transmitter;
a QAM receiver;
a test controller operable to configure the QAM receiver and the QAM transmitter for an internal test; and
a test coupler operable to couple an output of the QAM transmitter to an input of the QAM receiver.

2. The apparatus of claim 1 wherein said test controller is further operable to provide a data signal and carrier frequency identification to said QAM transmitter for controlling the QAM transmitter.

3. The apparatus of claim 2 wherein the test controller is further operable to evaluate the response of the QAM receiver to the data signal used to control said QAM transmitter.

4. The apparatus of claim 3 wherein the test controller is further operable to configure the QAM transmitter for a symbol rate during said internal test.

5. The apparatus of claim 1 wherein the test coupler is operable to selectively couple the output of the QAM transmitter to one of a front end component and a SAW filter of the QAM receiver.

6. The apparatus of claim 4 wherein the symbol rate is within the bandwidth of a surface acoustic wave (SAW) filter coupled to the QAM receiver.

7. A device for internally testing a component of a CATV network comprising: a test controller operable to configure a quadrature amplitude modulated (QAM) receiver and a QAM transmitter within a unit under test for an internal test; and a test coupler operable to coupling an output of the QAM transmitter to an input of the QAM receiver.

8. The device of claim 7 wherein said test controller is further operable to provide a data signal and carrier frequency identification to said QAM transmitter for controlling the QAM transmitter.

9. The device of claim 8 wherein the test controller is further operable to evaluate the response of the QAM receiver to the data signal used to control said QAM transmitter.

10. The device of claim 9 wherein the test controller is further operable to configure the QAM transmitter for a symbol rate during said internal test.

11. The device of claim 7 wherein the test coupler is further operable to selectively couple the output of the QAM transmitter to one of a front end component and a SAW filter of the QAM receiver.

12. The device of claim 10 wherein the symbol rate is within the bandwidth of a surface acoustic wave (SAW) filter coupled to the QAM receiver.

13. A method for determining phase response of a channel in a CATV system comprising:
configuring a QAM transmitter and a QAM receiver for an internal test of the QAM receiver; and
coupling an output of the QAM transmitter to an input of the QAM receiver.

14. The method of claim 13 wherein the configuration of the QAM transmitter includes providing a data signal and a carrier frequency identification to said QAM transmitter.

15. The method of claim 14, the evaluation further comprising:
comparing a response received from the QAM receiver with the data signal provided to the QAM transmitter.

16. The method of claim 13 wherein the configuration of the QAM transmitter includes identification of a symbol rate for the QAM transmitter.

17. The method of claim 16 wherein the symbol rate is within the bandwidth of a SAW filter coupled to the QAM receiver.

18. The method of claim 13 wherein the coupling includes selectively coupling the output of the transmitter to one of a front end component and a SAW filter of the QAM receiver.
